(19) United States
(12) Patent Application Publication
(10) Pub. No.: US 2008/0060989 A1
(43) Pub. Date: Mar. 13, 2008

(54) Water purification system

(76) Inventors: Rajiv Manoher Banavall, Rydal, PA (US); Jose Antonio Trejo, Lansdale, PA (US)

Correspondence Address: ROHM AND HAAS COMPANY;PATENT DEPARTMENT, 100 INDEPENDENCE MALL WEST, PHILADELPHIA, PA, 19106-2399, US

(21) Appl. No.: 11/893,563

(22) Filed: Aug. 16, 2007

Related U.S. Application Data
(60) Provisional application No. 60/842,745, filed on Sep. 7, 2006.

(51) Int. Cl. B01D 27/02

(52) U.S. Cl. 210/287

(57) ABSTRACT

The present invention relates to a water purification system useful for arsenic removal.

This application claims the benefit of priority under 35 U.S.C. §119(e) of U.S. Provisional Patent Application No. 60/842,745, filed on Sep. 7, 2006, the disclosure of which is incorporated herein by reference.

The present invention relates to a water purification system consisting of multiple layers of media for removing toxic impurities from water or other aqueous solutions.

Purification or filtration of water or other aqueous solutions is necessary for many applications, from the provision of safe or potable drinking water to biotechnology applications including fermentation processing and separation of components from biological fluids, and to industrial processes that require waste stream treatment and recovery of process chemicals. In recent years, the need for water filtration and purification in the home has become more recognized, and the competing concerns of energy efficiency and residential fluid quality have lead to the development of numerous filtration products.

There are many well-known methods currently used for water purification, such as reverse osmosis, distillation, ion-exchange, chemical adsorption, coagulation, and filtering or retention. Particle filtration may be completed through the use of membranes or layers of granular materials. Other fluid purification techniques involve chemical introduction which alters the state or chemical identity of the contaminant. One such filtration system is disclosed in U.S. Pat. No. 6,383,395.

In many fluid purification applications, including the one disclosed in U.S. Pat. No. 6,383,395, a combination of techniques are required in order to completely purify fluids, such as water. Combinations of technologies may be implemented by combining functions in a single device or using several different devices and technologies in series where each performs a distinct function. Examples of this practice include the use of mixed ion-exchange resins that remove both negative and positively charged chemical species and oxidation/filtration methods where oxidizers are used to generate particulate matter that may be subsequently filtered.

Many of these fluid purification technologies, techniques, and practices are costly, energy inefficient and/or require significant technical know-how and sophistication to implement on both large and small scales. As a result, many advanced fluid purification technologies have had limited application in residential point of entry (POE) and point of use (POU) applications; particularly in Third World countries who require efficient water purification systems at low cost.

The present invention has solved this problem by providing a cost and energy efficient water purification filtration system whose primary purpose is to remove naturally occurring arsenic from water, but is also capable of removing other heavy metals and organics. The gravity operated system is simple, robust, and affordable for homeowner use in undeveloped areas of the world, where electricity is not widely available and more expensive technologies are not affordable.

In the present invention there is provided a device for purifying solutions comprising:
i. a first container
ii. an inlet tube comprising two ends wherein the first end of the inlet tube extends into the first container;
iii. a cartridge having two ends comprising media wherein the second end of the inlet tube attaches to the cartridge
iv. an outlet tube comprising two ends wherein the first end of the outlet tube extends from the cartridge; and
v. a second container wherein the second end of the outlet tube extends into the second container
   wherein the media comprises: limestone particles at least partially coated with an iron oxyhydroxide; activated carbon; and uncoated limestone particles.

Additionally, the two ends of the cartridge comprise an upper end and a lower end wherein the upper end is in the upper third of the cartridge and the lower end is in the lower third of the cartridge. Alternatively, the second end of the inlet tube may attach to the lower end of the cartridge. Still another alternative is for the first end of the outlet tube to extend out of the upper end of the cartridge. In addition to being used independently, these alternatives may also be employed in combination in the system.

According to the present invention, the media contained in the first container is limestone, iron activated carbon and iron coated limestone particles. The iron content for the activated carbon is between 3 and 15 percent as measured by weight percent as measured by iron on a dry basis. The iron content for the iron coated limestone is between 2 and 10 weight percent as measured by percent iron on a dry basis. The particle size of the activated carbon used is ranges from 500 to 1190 microns and the particle size of the limestone ranges from 76 to 600 microns. The BET of the iron coated limestone is 25-35 m2/g with pore diameter 30-48 Angstroms.

This configuration of media allows for the removal of arsenic and other heavy metals and organic toxins. Such toxins include but are not limited to Fe, Pb, Cd, Cu, Cr, Hg, Ni, Al, Sb, Ba, Be, Mn, Se, Ra, and Th. Furthermore anions in water such as arsenate, phosphate, silica, fluoride, borate, chromate, arsenite, nitrate, nitrite and uranyl; natural organic matter such as humic acid, and cyano compounds may be removed by the present invention.

Control of the pH of the effluent is a benefit of the system of the present invention. The pH of the water or other aqueous solutions will range from 7.8 to 8.3. This pH range is especially beneficial for providing potable water.

The present invention further provides a water purifying assembly comprised of a water inlet tube, valves, a cartridge or first container with treatment media and water outlet tube. The water inlet tube can be connected to a locally supplied water feed container. The discharge through the outlet tube from the cartridge or container directs purified water to a second container or receptacle vessel. The cartridge or first container may optionally be connected to a detachable mounting board for stability. Additionally, the water purification assembly may employ various means for controlling the flow of the fluid through the system. Such means include but are not limited to: gravity, pressure fed, and pump assisted flow. Each of these methods is dependant on the particular application; for example whether the system is for commercial use or for residential or for the type of fluid that is being used in the system.

### BRIEF DESCRIPTION OF THE DRAWINGS

FIG. 1a is a cross-sectional view of a cartridge constructed according to the teachings of the present invention. In this illustration the media is horizontally packed into the cartridge.

FIG. 1b is a cross-sectional view of an alternate design for the cartridge constructed according to the teachings of the present invention. FIG. 1b illustrates how the media may also be vertically packed within the cartridge.

FIG. 1c is a cross-sectional view of one alternative for packing of the three layers of media.

FIG. 2 is a view of a water purification assembly according to the teachings of the present invention.

### DETAILS

### REFERENCE NUMERALS

1 filter 1
2 untreated limestone
3 filter 2
4 iron imbibed activated carbon
5 iron activated limestone
6 cartridge
7 inlet end
8 outlet end
9 media
10 pleated filter
20 untreated limestone packing
21 iron imbibed activated carbon packing
22 iron activated limestone packing
30 first feed container
31 first end of the inlet tube
32 inlet tube
33 second end of the inlet tube
34 cartridge (full outer view)
35 outlet end of cartridge
36 outlet tube
37 second end of the outlet tube
38 second container
39 spigot
40 flow control valve
41 inlet end of cartridge
42 first end of the outlet tube

### DETAILED DESCRIPTION OF THE DRAWINGS

### Cartridge

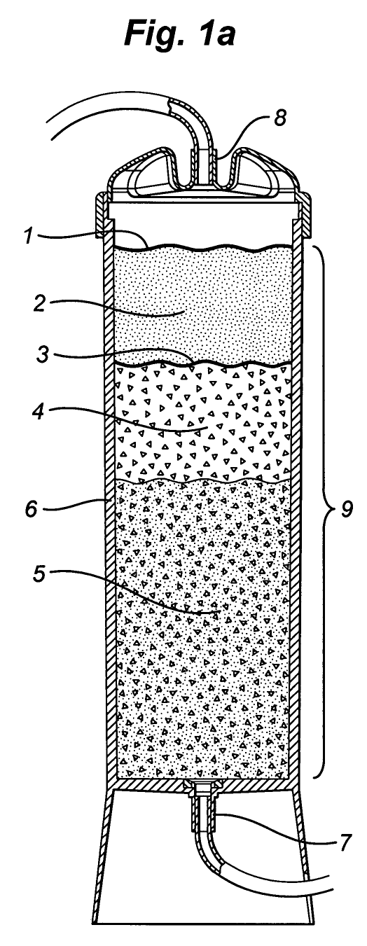

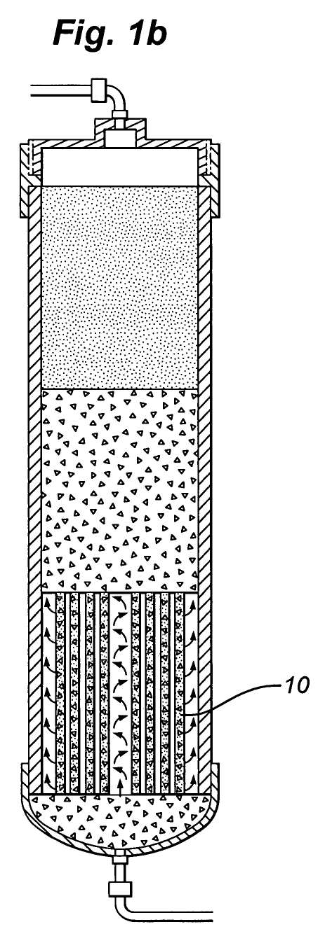

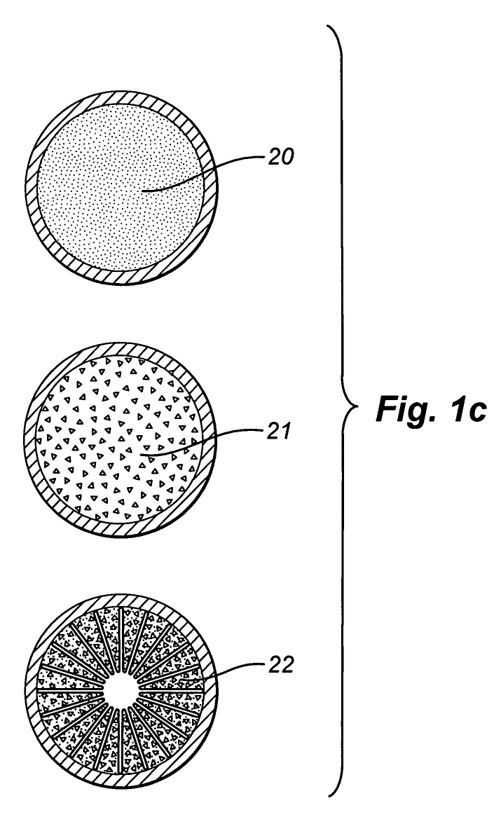

A cartridge design for residential use is shown in FIG. 1a. Although FIG. 1a depicts one design of a cartridge, the figure is not intended to be limiting. One of ordinary skill in the art would recognize that this design is not limited to residential use but may be expanded and/or modified for commercial use. As depicted in FIG. 1, for residential use, the cartridge (6) can be fabricated from typical polymeric materials, for example, polyvinyl chloride, polypropylene, polyethylene, polyethylenterephtalate, ceramic, metal or natural materials. The internal volume can be varied to suit the particular media (9) loading need for the targeted liquid composition which can vary. A typical height of the column for household use ranges from 0.20-0.50 meters. Typical internal volume is the range of 0.1 to 10 liters, preferably 2 to 3 liters. Typical internal volume for municipal systems could be up to 10000 liters, or with up to 100 cartridges arranged in a parallel flow pattern. The cartridge is free standing on a base and contains inlet (7) and outlet (8) ends, optionally nozzles properly sized to fit any given tubing.

The cartridge is filled with the media (9) described in Table 1. These ingredients ensure arsenic and heavy metal removal from water, as well as water that is colorless and odorless

TABLE 1
Contents of column

Filter 1 (1)
untreated limestone (2)
Filter 2 (3)
iron imbibed activated carbon (4)
iron activated limestone (5)

The range in %-volume of the different media can be defined to be 1-70% for the limestone untreated material 0-70% for the iron imbibed activated carbon, and 30%-99% for the iron coated limestone. The preferable range in % volume: for the media is 25-30% untreated limestone, 18-22% iron-activated carbon and 48-54% iron coated limestone.

An alternative cartridge design concept is shown in FIG. 1b. This design uses pleated filter (10) media to guide the water through a more plug flow pattern to prevent channeling and more efficiently uses the media.

FIG. 1c shows a cross-sectional view of each of the three layers of packing. The first illustration (20) depicts the untreated limestone packed into the cartridge. The second illustration (21) depicts the iron imbibed activated carbon packed into the cartridge. The third illustration (22) depicts the iron activated limestone packed in a pleated formation into the cartridge.

### Water Purifying Assembly

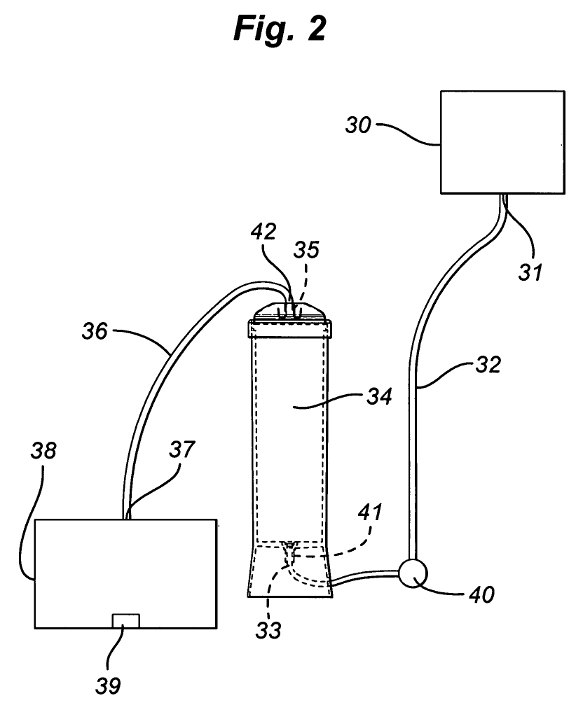

One design for an entire water purifying assembly for residential use is shown in FIG. 2. The system, as depicted in, FIG. 2, is designed to require minimal assembly. The figure is not meant to limit the invention to the representation presented. It is conceivable that one of ordinary skill in the art may modify and or expand this representation so that it is practical for commercial and other uses. However, with regard to the figure depicted, a potential user will fill the first feed container (30) with an untreated solution. In the case of a gravity operated system, the height differential between the feed container (30) and the cartridge (34) provides sufficient head pressure for water to flow by gravity through the first end (31) of the inlet tube (32), through to the second end (33) of the inlet tube to the inlet end of the cartridge (41). Optionally, a flow control valve (40) may be incorporated onto the inlet tube to control the flow rate of the fluid. Ideally, the flow control valve (40) is set to a specific location so that the starting flow rate is between 50 and 500 ml/min, preferably between 100-200 ml/min. Water flow through the column is from bottom to top which allows for the use of a minimal amount of media during flow and relatively steady flow rate during the life of the cartridge (34). Treated water will pass from the outlet of the cartridge (35) through the first end of the outlet tube (42), through the outlet tube (36), through the second end of the outlet tube (37) and into the second container (38) for storage which is optionally equipped with a spigot for dispensing the water (39).

### EXAMPLES

### Example 1

The system was set up as shown in FIG. 2. A 50 liter carboy of deionized water was spiked with 150 ppb As(III) and 150 ppb As(V), 2 ppm Fe(II). The solution measured at pH 6.5. The cartridge column was packed with 1.0 liters of iron activated limestone 0.2-0.5 mm, 0.5 liters of untreated limestone, and 0.5 liters of iron activated carbon, (See FIG. 1). ⅜″ tubing was connected from a first source container to column; air was bled out of line; and the flow control valve was set for initial flow rate of 180 ml/minute. Water flowing out of the column was collected in a 50 liter second container and analyzed periodically during the run.

Tests have been conducted that demonstrate the treatment of 20- and 50-liter batches of arsenic-containing water at an average flow rate of 160 ml/min. One cartridge has been shown to treat more than 4,000 liters of water by running multiple batches per day over several weeks. Arsenic III and V have been reduced from 300 ppb (150 ppb each III and V) to less than 10 ppb over this several week period. Furthermore other benefits were realized such as the reduction of other ions, pH control and improvement in water color and clarity.

Table 2 below illustrates this proposition

TABLE 2
Arsenic Concentration vs Total Water Flowed Through System

| Accumulated Liters | As III and V (ppb) |
|---|---|
| 0 | 0 |
| 100 | 0 |
| 200 | 0 |
| 300 | 0 |
| 400 | 0 |
| 500 | 0 |
| 600 | 0 |
| 700 | 0 |
| 800 | 0 |
| 900 | 0 |
| 1000 | 0 |
| 1100 | 0 |
| 1200 | 0 |
| 1300 | 0 |
| 1400 | 0 |
| 1500 | 0 |
| 1600 | 0 |
| 1700 | 0 |
| 1800 | 0 |
| 1900 | 0 |
| 2000 | 0 |
| 2100 | 0 |
| 2200 | 0 |
| 2300 | 0 |
| 2400 | 1 |
| 2500 | 1 |
| 2600 | 1 |
| 2700 | 1 |
| 2800 | 1 |
| 2900 | 1 |
| 3000 | 1 |
| 3100 | 2 |
| 3200 | 2 |
| 3300 | 2 |
| 3400 | 2 |
| 3500 | 3 |
| 3600 | 3 |
| 3700 | 3 |
| 3800 | 3 |
| 3900 | 5 |
| 4000 | 5 |

The influent water, prior to running through the system contained 300 ppb As, 2 ppm Fe(II) and had a pH of 6.5. Arsenic was measured by ICP-MS.

What is claimed is:

1. A device for purifying solutions comprising:
i. a first container
ii. an inlet tube comprising two ends wherein the first end of the inlet tube extends into the first container;
iii. a cartridge having two ends comprising media wherein the second end of the inlet tube attaches to the cartridge
iv. an outlet tube comprising two ends wherein the first end of the outlet tube extends from the cartridge; and
v. a second container wherein the second end of the outlet tube extends into the second container
wherein the media comprises: limestone particles at least partially coated with an iron oxyhydroxide; activated carbon; and uncoated limestone particles.

2. The device of claim 1 wherein the device comprises a pump.

3. The device of claim 1 wherein the two ends of the cartridge comprise an upper end and a lower end wherein the upper end is in the upper third of the cartridge and the lower end is in the lower third of the cartridge.

4. The device of claim 3 wherein the second end of the inlet tube attaches to the lower end of the cartridge.

5. The device of claim 3 wherein the first end of the outlet tube extends out of the upper end of the cartridge.

6. The device of claim 4 wherein the first end of the outlet tube extends out of the upper end of the cartridge.
